(19) United States
(12) Patent Application Publication
(10) Pub. No.: US 2006/0225287 A1
(43) Pub. Date: Oct. 12, 2006

(54) SELF-BAGGING HEDGE TRIMMER

(76) Inventor: Edward W. Mack, Philadelphia, PA (US)

Correspondence Address: HOWARD M COHN;PATENT ATTORNEY LLC, 21625 CHAGRIN BLVD #220, CLEVELAND, OH, 44122, US

(21) Appl. No.: 11/278,730

(22) Filed: Apr. 5, 2006

Related U.S. Application Data
(60) Provisional application No. 60/668,793, filed on Apr. 6, 2005.

(51) Int. Cl. B26B 19/02; B26B 19/12

(52) U.S. Cl. 30/208; 30/216

(57) ABSTRACT

The present invention is disclosed a cutting and bagging apparatus intended for attachment to a hedge trimmer having a reciprocating cutting blade. The apparatus comprises a collection hood; structure for connecting the collection hood to the hedge trimmer; cutting and grinding structure disposed within the collection hood; power delivery structure for driving the cutting and grinding means; and a flexible pipe attached to said collection hood and communicating with a holding bag.

### CROSS-REFERENCE TO RELATED APPLICATIONS

This application claims the benefit of U.S. Provisional Patent Application No. 60/668,793 filed on Apr. 6, 2005 which is incorporated herein by reference.

### FIELD OF THE INVENTION

The present invention relates to hedge trimmers and more particularly to self-powered hedge trimmers.

### BACKGROUND

The trimming of hedges inevitably involves the problem of the fallen trimmings, which often if not usually get caught within the hedge being trimmed. The person doing the trimming is thus forced to remove the trimmings by hand, often having to reach deep into the hedge to retrieve small pieces which, if left in place, will interfere with the hedge's growth and health and also, and most immediately, with the hedge's aesthetic appearance.

A person who uses a hand-powered trimmer or hedger might chop off a multiplicity of branches at one time, or they might choose to trim each branch singly while holding the branch to be trimmed and thence discarding it into a bag or upon the ground from which it can later be raked up with relative ease.

When self-powered hedgers are used, whether gasoline or electric powered, the volume of trimmed material is much greater than with hand-powered hedgers or trimmers. The main adverse result of the use of self-powered trimmers is that the sheer volume of clippings far exceeds an amount that can be caught by hand before the clippings fall into the hedge. Not only that, but there is intrinsic hazard in trying to hand-catch hedge clippings when using an electric or gasoline trimmer. Therefore, the use of self-powered hedge trimmers inevitably causes large amounts of hedge trimmings to fall into the hedge being trimmed. The time-saving benefits of self-powered trimmers easily become neutralized by the amount of time and work required to hand-pick the resultant trimmings from the hedge being trimmed.

There are known various cutters to be used for grass or hedge trimming. Some of these devices even collect the trimmings after the cutting operation. Most of the hedge trimmers are relatively cumbersome to operate; some are heavy and others have limited trimming retention capacity. Some of these devices are disclosed in U.S. Pat. Nos. 5,588,289 and 5,862,595.

U.S. Pat. No. 5,588,289 to Wilson discloses a cutting tool for gardens and workshops that has a driven impeller to accommodate transporting clippings from a cutting area to a collection container. The clippings must travel a substantial distance in the Wilson device and thereby create a high probability of that the clippings will clog during their movement to the collection device. Also, the device is relatively heavy with a motor in the cutting body A and a motor located in the back pack as shown in Wilson's FIG. 12. The device is heavy, complicated, somewhat expensive, and could be difficult because of its weight to wear and use for any extended period of time.

U.S. Pat. No. 5,862,595 to Keane discloses a hand-holdable trimmer for garden and lawn applications that has a relatively long, elongated housing defining an air passage extending from the trimmer's rotating trimmer head to a collection container for cuttings mounted distally on the housing. An impeller wheel driven by the trimmer motor causes air to flow under positive pressure from the region surrounding the trimmer head, through the housing air passage, and to eventually deliver the trimmer cuttings to the collection container. A dual, axially adjustable trimmer head assembly also is provided to more efficiently cut grass, weeds, etc. into small pieces capable of being transferred to the collection container. Keane uses a flexible string as the cutting device. A long conduit from the cutting device to the collection container increases the possibility of clogging of especially coarse hedge trimmings therein.

There remains a problem to provide a device which is lightweight, portable and able to easily collect trimmings from a hedge being trimmed and to be able to easily dispose of the clippings.

### SUMMARY OF THE INVENTION

According to the present invention, there is disclosed a cutting and bagging apparatus intended for attachment to a hedge trimmer having a reciprocating cutting blade. The apparatus comprises a collection hood; structure for connecting the collection hood to the hedge trimmer; cutting and grinding structure disposed within the collection hood; power delivery structure for driving the cutting and grinding means; and a flexible pipe attached to said collection hood and communicating with a holding bag.

Further according to the present invention, the cutting and grinding structure includes two or more cutting blades contained within the collection hood. The two or more cutting blades are driven in the same rotational direction so that they cross in opposite directions under the collection hood and cut and grind trimmed hedge clippings being pulled into the collection hood. One or more cutting blades are shaped like propellers so as to produce a powerful draft of air that can pull the hedge clippings from the reciprocating cutting blade of the hedge trimmer into the hood and then move the cut or ground trimmed hedge clippings into the pipe and then into the holding bag.

Also according to the present invention, the cutting and bagging device is attached to the hedge trimmer by means of the cantilevered support attachment. The cantilevered support attachment contains power delivery structure for conveying power to the cutting and grinding structure.

Further according to the present invention, the power delivery structure is a belt for conveying motive power to rotate the cutting blades. The belt carries power from a power source of the hedge clipper. The two or more cutting blades are mounted upon shafts within the collection hood. Each shaft has a pulley attached thereto and each pulley is driven by the belt to convey motive power to rotate the cutting blades.

Still further according to the present invention, the power source of the hedge clipper for rotating the cutter blades is a motor. The power source for rotating the cutter blades can be an electric motor or a gasoline motor.

Also according to the present invention, the power delivery means is a chain for conveying motive power to rotate the cutting blades.

According to the present invention, the collection hood of the cutting and bagging device has a domed like shape with an inlet opening disposed directly above the reciprocating cutting blade of the hedge trimmer; and an outlet opening disposed opposite the inlet opening and extending through the hood.

Also according to the present invention, the flexible pipe is secured at one end to the outlet opening of the collection hood and the opposite end of pipe is connected to an inlet opening of a holding bag.

Still further according to the present invention, the holding bag is adapted to be carried by the user. The holding bag incorporates carrying straps that are suitable for making the bag wearable upon the back of the user of the hedge trimmer. The holding bag also has a detachable cap, whereby the captured or held clippings that are conveyed to the bag by means of the flexible pipe may be removed from the bag when it becomes full of ground-up clippings.

Yet further according to the present invention, the collection hood of the cutting and bagging device is more or less hemispherical in shape and contains within itself the structure for cutting and grinding the captured or held clippings.

### BRIEF DESCRIPTIONS OF THE FIGURES

The structure, operation, and advantages of the present invention will become further apparent upon consideration of the following description taken in conjunction with the accompanying figures (Figs.). The figures are intended to be illustrative, not limiting.

Certain elements in some of the figures may be omitted, or illustrated not-to-scale, for illustrative clarity. The cross-sectional views may be in the form of “slices”, or “near-sighted” cross-sectional views, omitting certain background lines which would otherwise be visible in a “true” cross-sectional view, for illustrative clarity.

In the drawings accompanying the description that follows, often both reference numerals and legends (labels, text descriptions) may be used to identify elements. If legends are provided, they are intended merely as an aid to the reader, and should not in any way be interpreted as limiting.

FIG. 1 is an oblique view of a hedge trimmer in combination with a suction catching device for capturing and bagging hedge trimmings; and

FIG. 2 is an orthogonal diagrammatic side view of the suction catching device of FIG. 1, showing the cutters and drive mechanism.

### DETAILED DESCRIPTION OF THE PREFERRED EMBODIMENT

The present invention is an integral suction and bagging invention intended for use with a self-powered hedge trimmer, or hedger, powered by gasoline or electricity. The suction bagging device includes a conduit that communicates with a holding bag. Hedge clippings produced by the self-powered trimmer or clipper device are conveyed by a conduit to a holding bag which can be worn in the style of a knapsack upon the back of the user of the hedger.

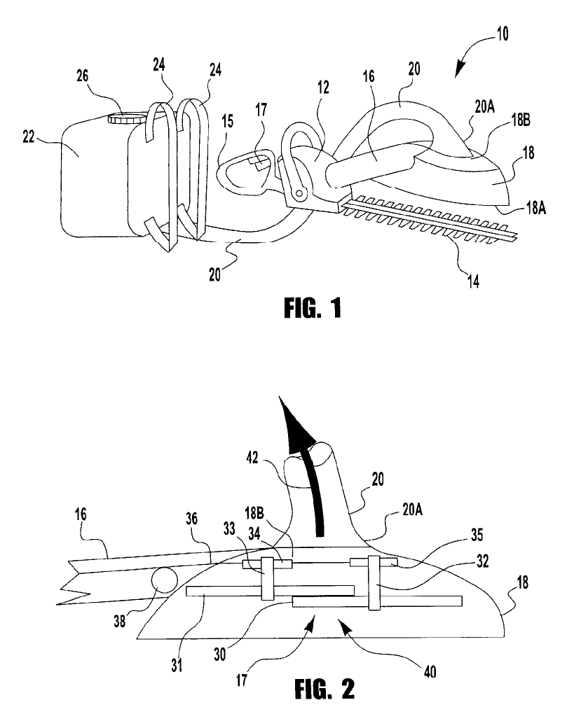

Referring to FIG. 1, a cutting and bagging device 10 is shown integrally mounted or attached to a hedge trimmer 12 having a reciprocating cutting blade 14, a handle 15 and an ON/OFF trigger 17. The cutting and bagging device 10 is attached to the hedge trimmer 12 by means of the cantilevered support attachment 16, which also contains a power delivery means 17 for conveying power to cutting blades (not shown in FIG. 1) that are contained within a collection hood 18 of the cutting and bagging device 10.

The collection hood 18 of the cutting and bagging device 10 has a domed like shape with an inlet opening 18A disposed directly above cutting blade 14 and an outlet opening 18B disposed opposite the inlet opening and extending through the hood. A flexible pipe or tube 20 is secured at one end 20A to the outlet opening 18B of the collection hood 18. The opposite end 20B of tube 20 is connected to an inlet opening (not shown) of a holding bag 22.

The holding bag 22 incorporates carrying straps 24 that are suitable for making the bag wearable upon the back, in the style of a knapsack, of the user of the hedge trimmer 12 incorporating the integral cutting and bagging device 10. The bag 22 also has a detachable cap or lid 26, whereby the captured or held clippings that are conveyed to the bag by means of the flexible pipe 20 may be removed from the bag when it becomes full of ground-up clippings.

Referring now to FIG. 2, the cutting and bagging device 10 is shown in a cross-sectional schematic view. The collection hood 18 of the cutting and bagging device 10 is more or less hemispherical in shape and contains within itself means 28 for cutting and grinding the captured or held clippings.

The cutting and grinding means 28 as shown in FIG. 2, include two or more rotating trimming blades 30 and 31 mounted upon shafts 32 and 33 respectively. The shafts 32 and 33 are supported in bearings (not shown) attached to the collection hood 18. Each shaft 32, 33 has, in the embodiment shown in FIG. 2, attached thereto a pulley 34, 35, respectively. The pulleys 34, 35 are driven by a belt 36 which conveys motive power to the spinning blades 30. The belt 36 carries power from the main motor of the hedge clipper 12. The belt 36 is housed within the hollowed cantilevered attachment 16, which is shown having therein one or more guide pulleys 38 (only one of which is visible) for guiding the belt to convey power to the blade pulleys 34, 35.

The rotating or spinning blades 30, 31 are driven in the same rotational direction, that is, either clockwise or counter clockwise, as viewed from any one direction, so that they cross in opposite directions in the region 40 under the collection hood 18, thereby supplying a cutting or grinding action upon trimmed hedge clippings. The blades 30,31 are also shaped like propellers so as to produce a powerful draft of air that can force the hedge clippings that get ground up in the region 40 to move into the tube 20 in the direction indicated by the arrow 42, and thence carried to the bag 22.

Though FIG. 2 shows rotating cutter blades that are driven by a belt 36, the inventors envision that the drive mechanism for the rotating cutter blades 30 might be one or more independent electric or gasoline motors, or that a drive chain might be used in place of the belt 36. The inventors further envision that the cutter blades might be driven by a drive shaft housed within the support 16, in combination with bevel gears attached to the shafts 32.

The inventors further envision that the suction feature might be incorporated within the bag 22, in the style of a bag-type vacuum cleaner, said suction feature being powered by gasoline or electricity.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, circuits, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

1. A cutting and bagging apparatus intended for attachment to a hedge trimmer having a reciprocating cutting blade, the apparatus comprising:
a collection hood;
means for connecting the collection hood to the hedge trimmer;
cutting and grinding means disposed within the collection hood;
power delivery means for driving the cutting and grinding means; and
a flexible pipe attached to said collection hood and communicating with a holding bag.

2. The cutting and bagging apparatus of claim 1 wherein the
cutting and grinding means includes two or more cutting blades contained within the collection hood.

3. The cutting and bagging apparatus of claim 2 wherein the two or more cutting blades are driven in the same rotational direction so that they cross in opposite directions under the collection hood and cut and grind trimmed hedge clippings being pulled into the collection hood.

4. The cutting and bagging apparatus of claim 3 wherein one or more cutting blades are shaped like propellers so as to produce a powerful draft of air that can pull the hedge clippings from the reciprocating cutting blade of the hedge trimmer into the hood and then move the cut or ground trimmed hedge clippings into the pipe and then into the holding bag.

5. The cutting and bagging apparatus of claim 1 wherein the cutting and bagging device is attached to the hedge trimmer by means of the cantilevered support attachment.

6. The cutting and bagging apparatus of claim 5 wherein the cantilevered support attachment contains a power delivery means for conveying power to the cutting and grinding means.

7. The cutting and bagging apparatus of claim 6 wherein the power delivery means is a belt for conveying motive power to rotate the cutting blades.

8. The cutting and bagging apparatus of claim 7 wherein the belt carries power from a power source of the hedge clipper.

9. The cutting and bagging apparatus of claim 7 wherein the two or more cutting blades are mounted upon shafts within the collection hood.

10. The cutting and bagging apparatus of claim 9 wherein:
each shaft has a pulley attached thereto; and
each pulley is driven by the belt to convey motive power to rotate the cutting blades.

11. The cutting and bagging apparatus of claim 8 wherein the power source of the hedge clipper for rotating the cutter blades is a motor.

12. The cutting and bagging apparatus of claim 11 wherein the power source for rotating the cutter blades is an electric motor.

13. The cutting and bagging apparatus of claim 11 wherein the power source for rotating the cutter blades is a gasoline motor.

14. The cutting and bagging apparatus of claim 6 wherein the power delivery means is a chain for conveying motive power to rotate the cutting blades.

15. The cutting and bagging apparatus of claim 1 wherein the collection hood of the cutting and bagging device has a domed like shape with an inlet opening disposed directly above the reciprocating cutting blade of the hedge trimmer; and
an outlet opening disposed opposite the inlet opening and extending through the hood.

16. The cutting and bagging apparatus of claim 15 wherein the flexible pipe is secured at one end to the outlet opening of the collection hood and the opposite end of pipe is connected to an inlet opening of a holding bag.

17. The cutting and bagging apparatus of claim 1 wherein the holding bag is adapted to be carried by the user.

18. The cutting and bagging apparatus of claim 17 wherein the holding bag incorporates carrying straps that are suitable for making the bag wearable upon the back of the user of the hedge trimmer.

19. The cutting and bagging apparatus of claim 17 wherein the holding bag also has a detachable cap, whereby the captured or held clippings that are conveyed to the bag by means of the flexible pipe may be removed from the bag when it becomes full of ground-up clippings.

20. The cutting and bagging apparatus of claim 1 wherein the collection hood of the cutting and bagging device is more or less hemispherical in shape and contains within itself the means for cutting and grinding the captured or held clippings.
